(19) United States
(12) Patent Application Publication
(10) Pub. No.: US 2017/0333989 A1
(43) Pub. Date: Nov. 23, 2017

(54) CONDUCTIVE PARTICLES, CONDUCTIVE POWDER, CONDUCTIVE POLYMER COMPOSITION AND ANISOTROPIC CONDUCTIVE SHEET

(71) Applicant: HITACHI METALS, LTD.

(72) Inventors: Hidehito MORI, Suita-shi, Osaka (JP); Tsutomu NOZAKA, Yasugi-shi, Shimane (JP)

(21) Appl. No.: 15/520,855

(22) PCT Filed: Sep. 29, 2015
(86) PCT No.: PCT/JP2015/077414

§ 371 Date: Apr. 21, 2017

(30) Foreign Application Priority Data
Oct. 24, 2014 (JP) 2014-217570

(51) Int. Cl. B22F 1/02; H01B 1/02; C22C 19/03; H01B 5/16; H01B 1/22; B22F 9/24

(52) U.S. Cl. CPC B22F 1/025; H01B 5/16; H01B 1/22; H01B 1/02; C22C 19/03; B22F 9/24

(57) ABSTRACT

A conductive particle including a conductive powder, a conductive polymer composition, and an anisotropic conductive sheet, each of which has a particularly smaller volume resistivity and better conductivity than those of the related art, and is desirably inexpensive. A conductive particle includes a first plating layer (pure Ni plating layer or Ni plating layer containing 4.0 mass % or less of P) covering the surface of a spherical Ni core containing 5 mass % to 15 mass % or less of P. The conductive particle may further include a Au plating layer having a thickness of from 5 nm to 200 nm and covering the surface of the first plating layer.

### TECHNICAL FIELD

The present invention relates to a conductive particle, a conductive powder, a conductive polymer composition, and an anisotropic conductive sheet.

### BACKGROUND ART

In recent years, a conductive particle using, as its core, a spherical Ni alloy particle containing a metalloid, for example, P, a conductive powder that is a collection of the conductive particles, a conductive polymer composition using the conductive powder, and a conductive sheet (conductive film) using the conductive polymer composition have been widely used in, for example, applications in which electronic parts are electrically connected to each other. In particular, in small electrical devices (e.g., cellular phones), an anisotropic conductive sheet and an anisotropic conductive film each having particular conductivity in a thickness direction thereof are widely utilized.

The Ni alloy particle is itself a conductive particle, but a Au plating layer, which is excellent in conductivity and stable in terms of metal characteristics, is generally formed on its surface. For example, in Patent Document No. 1, there are disclosed a crystalline Ni alloy particle (core) containing a metalloid (e.g., C, B, P, Si, As, Te, Ge, or Sb), and a conductive particle having a structure including a Au plating layer having a thickness of 1 μm or less on a surface of the core. In Patent Document No. 2, there are disclosed a spherical NiP fine particle (core) mainly formed of Ni and containing P, and having a surface layer portion having dispersed therein a NiP intermetallic compound, and a conductive particle having a structure including a Au plating layer on a surface of the core. In Patent Document No. 3, there are disclosed a reductive precipitation-type spherical NiP fine particle (core) that contains Ni, P, and Cu, and that may further contain Sn, a production method therefor, and a conductive particle having a structure including Au on a surface of the core.

In addition, in each of Patent Documents Nos. 4 and 5, there is disclosed a conductive particle having a structure including a Pd layer at an outermost surface of a conductive fine particle. In Patent Document No. 4, there is disclosed a conductive particle having a structure including, on a surface of, for example, a resin fine particle (core), a plating layer containing Ni and 7 mass % or more of P and having a thickness of, for example, from 40 nm to 150 nm, and further including, at the outermost surface, a Pd layer having a thickness of, for example, from 10 nm to 50 nm. In Patent Document No. 5, there is disclosed a conductive particle having a structure including, on a surface of a core particle (core) whose material is not limited, an undercoating film of a crystal structure containing Ni and 1 mass % or more and less than 10 mass % of P, including, on a surface of the undercoating film, an upper layer film of a crystal structure containing Ni, P, and M (one or more kinds of W, Pd, Pt, and Mo), and further including an outermost layer film formed of Au or Pd.

### CITATION LIST

### Patent Literature

Patent Document No. 1: Japanese Patent Application Laid-Open Publication No. 2002-363603

Patent Document No. 2: Japanese Patent Application Laid-Open Publication No. 2006-131978

Patent Document No. 3: Japanese Patent Application Laid-Open Publication No. 2009-197317

Patent Document No. 4: Japanese Patent Application Laid-Open Publication No. 2011-175951

Patent Document No. 5: Japanese Patent Application Laid-Open Publication No. 2014-13660

### SUMMARY OF INVENTION

### Technical Problem

The conductive particles disclosed in Patent Documents Nos. 1 to 3 each use, as its core, a Ni particle containing Ni, P, and the like (hereinafter referred to as “NiP particle”). The NiP particle is itself a conductive particle, and is produced by, for example, a wet electroless reduction reaction involving using hypophosphorous acid as a reducing agent. However, the NiP particle containing P and the like has a larger volume resistance value and lower conductivity than those of a high-purity Ni particle that does not contain P or the like (hereinafter referred to as “pure Ni particle”). The pure Ni particle may be produced by, for example, a wet electroless reduction reaction involving using hydrazine as a reducing agent, but its maximum particle diameter producible is, for example, 5 μm. Accordingly, the NiP particle is used when a particle diameter of, for example, from 20 μm to 50 μm is required. In addition, the conductive particle disclosed in Patent Document No. 4 or 5 can use a non-metallic particle as its core. However, the volume resistivity of the non-metallic particle is much larger than that of the NiP particle, resulting in lower conductivity.

When the core has a large volume resistivity and low conductivity as described above, the volume resistivity of the core itself is not paid attention to, and as disclosed in each of Patent Documents Nos. 1 to 5, the conductivity is enhanced solely by forming a Au plating layer having good conductivity on the surface of the NiP particle or the non-metallic particle serving as the core, to thereby decrease the volume resistivity of the particle as a whole. However, the Au plating layer, which hardly undergoes a change in conductivity over time and hence is frequently used, is expensive. The application of, for example, Ag, Cu, or Al in place of Au is also conceivable. However, Ag, which has better conductivity than that of Au, has problems such as migration, sulfidation, and oxidation. Cu or Al has good conductivity, but has a problem such as oxidation. Further, Al cannot be used in aqueous plating, and hence has a problem in that the cost of the formation of an Al layer is high. A Pd plating layer that has heretofore been used has lower conductivity than that of a Au plating layer of the same thickness, and hence needs to have a sufficiently large thickness.

It is an object of the present invention to provide a conductive particle having a volume resistivity particularly smaller than that of the related art when directed to a conductive particle formed of a NiP particle that does not have a Au plating layer at its outermost surface.

It is another object of the present invention to provide a conductive particle having a volume resistivity smaller than that of the related art when directed to a conductive particle formed of a NiP particle that has a Au plating layer at its outermost surface, and to provide, depending on required conductive performance, an inexpensive conductive particle in which the Au plating layer has a thickness smaller than that of the related art.

It is another object of the present invention to provide, through the application of the conductive particle formed of a NiP particle and having a volume resistivity smaller than that of the related art, a conductive powder that is a collection of the conductive particles, a conductive polymer composition using the conductive powder, and an anisotropic conductive sheet using the conductive polymer composition.

### Solution to Problem

The inventors of the present invention have found a relationship between the amount of P contained in a NiP particle and the volume resistivity of the NiP particle, and have also found a novel structure of a conductive particle applicable even to a related-art NiP particle produced by a wet electroless reduction reaction involving using hypophosphorous acid as a reducing agent. Thus, the inventors have reached the present invention.

That is, a conductive particle according to one embodiment of the present invention includes: a spherical Ni core containing 5 mass % or more and 15 mass % or less of P; and a first plating layer covering a surface of the Ni core, in which the first plating layer includes a pure Ni plating layer or a Ni plating layer containing 4.0 mass % or less of P. The first plating layer has a thickness of 0.1 pun or more and 10 μm or less.

In one embodiment, the Ni core has a diameter of 1 μm or more and 100 μm or less.

In one embodiment, the conductive particle further includes a second plating layer covering a surface of the first plating layer, in which the second plating layer includes a Au plating layer having a thickness of 5 nm or more and 200 nm or less.

A conductive powder according to one embodiment of the present invention is a powder including any one of the above-mentioned conductive particles, the powder having a median diameter d50 in a cumulative volume distribution curve of 3 μm or more and 100 μm or less, and satisfying (d90−d10)/d50≦0.8.

A conductive polymer composition according to one embodiment of the present invention includes: the above-mentioned conductive powder; and a polymer, in which the polymer includes, for example, a rubber, a thermoplastic resin, a thermosetting resin, or a photocurable resin.

An anisotropic conductive sheet according to one embodiment of the present invention includes the above-mentioned conductive polymer composition, in which the conductive particles are arranged in a thickness direction of the anisotropic conductive sheet.

### Advantageous Effects of Invention

According to the present invention, the volume resistivity of the conductive particle formed of the NiP particle that does not have a Au plating layer at its outermost surface can be made particularly smaller than that of the related art. In addition, the volume resistivity of the conductive particle formed of the NiP particle that has a Au plating layer at its outermost surface can be made smaller than that of the related art. In addition, in this structure, depending on required conductive performance, the inexpensive conductive particle in which the Au plating layer has a thickness smaller than that of the related art can be provided. Accordingly, through the application of the conductive particle according to the embodiment of the present invention, the conductive powder that is a collection of the conductive particles each having a volume resistivity smaller than that of the related art, that is, the conductive particles each having better conductivity is obtained, and the conductive polymer composition and the anisotropic conductive sheet each using the conductive powder and having good conductivity are obtained.

### BRIEF DESCRIPTION OF DRAWINGS

FIG. 1 is a view for illustrating a cross-sectional image of a conductive particle according to an embodiment of the present invention.

FIG. 2 is a view for illustrating a cross-sectional image of a conductive particle according to another embodiment of the present invention.

FIG. 3 is a view (photograph) for showing a cross-sectional SEM image of a conductive particle 10a of Example 2.

FIG. 4 is a view for illustrating the structure of an apparatus used for the measurement of the volume resistivity of a conductive particle.

### DESCRIPTION OF EMBODIMENTS

An important feature in the present invention resides in a structure including a pure Ni plating layer or a Ni plating layer containing a small amount of P on a surface of a spherical Ni core containing P (NiP particle).

A conductive particle according to one embodiment of the present invention includes: a spherical Ni core containing 5 mass % or more and 15 mass % or less of P; and a first plating layer covering a surface of the Ni core, in which the first plating layer includes a pure Ni plating layer or a Ni plating layer containing 4.0 mass % or less of P. A related-art NiP particle, which generally uses hypophosphorous acid as a reducing agent as described above, contains 5 mass % or more of P. Accordingly, the first plating layer according to the present invention is the Ni plating layer containing 4.0 mass % or less of P so as to ensure that the content of P is smaller than that in the Ni core in consideration of a variation in content of P. When the content of P in the Ni plating layer is less than 0.1 mass %, the first plating layer corresponds to the pure Ni plating layer substantially free of P. With this structure, the conductive particle according to the present invention can have a volume resistivity particularly smaller than that of the related-art NiP particle.

Now, a conductive particle, a conductive powder, a conductive polymer composition, and an anisotropic conductive sheet according to embodiments of the present invention are described with appropriate reference to the drawings.

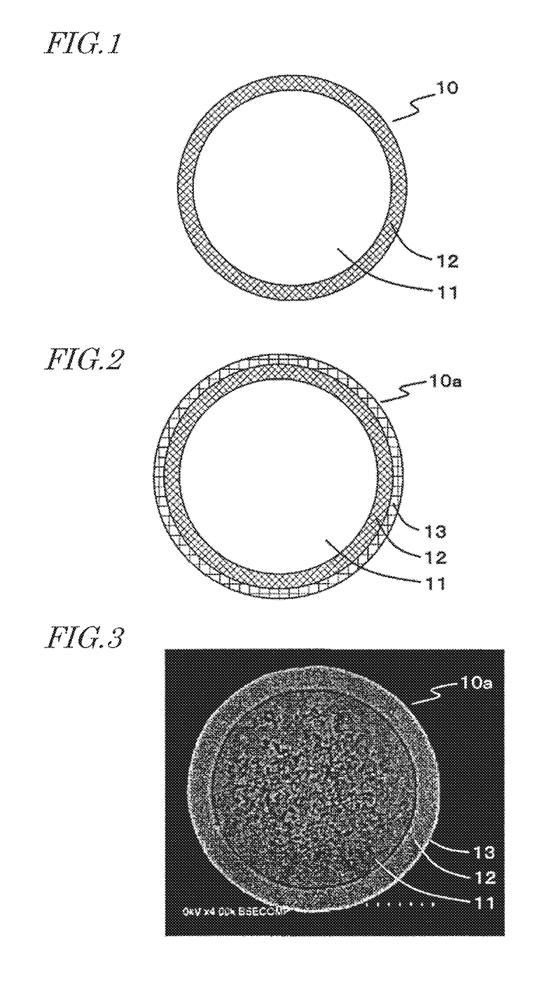

FIG. 1 is a cross-sectional image of a conductive particle 10 according to an embodiment of the present invention. The conductive particle 10 includes a spherical Ni core 11 containing Ni and P (NiP particle), and a first plating layer 12 covering the surface of the Ni core 11. The term “spherical” as used in the present invention assumes, but is not necessarily limited to, a sphere or a shape similar thereto having a sphericity of 0.80 or more because, for example, the Ni core 11 is required to have a non-flat shape when used for an anisotropic conductive sheet. In addition, the sphericity indicates a deviation from a sphere, and is an arithmetic average value calculated when the diameter of each of a plurality of particles is divided by its long diameter. A value for the sphericity closer to an upper limit of 1.00 indicates a shape closer to a sphere.

In addition, FIG. 2 is a cross-sectional image of a conductive particle 10a according to another embodiment of the present invention. A conductive particle 10a includes the spherical Ni core 11 containing Ni and P (NiP particle), the first plating layer 12 covering the surface of the Ni core 11, and a Au plating layer 13 covering the surface of the first plating layer 12. For the sake of simple description, common reference symbols are used in FIG. 1 and FIG. 2.

The diameter (particle diameter) of the Ni core 11 to be used for the conductive particle 10, 10a is preferably, for example, 1 μm or more and 100 μm or less. When the diameter of the Ni core 11 is less than 1 μm, aggregation of the Ni cores 11 becomes intense, and hence the Ni cores 11 are not easy to handle as a collection (powder). When the diameter of the Ni core 11 is more than 100 μm, there is an increased risk in that the Ni core 11 may protrude from a conductive path to cause, for example, a short circuit between adjacent wires. In addition, the diameter of the Ni core 11 is preferably 3 μm or more, and is preferably 30 μm or less. The case where the diameter of the Ni core 11 is 3 μm or more is practical because the aggregation of the Ni cores 11 is alleviated in a plating treatment for forming the first plating layer. In the case where the diameter of the Ni core 11 is 30 μm or less, the protrusion from the conductive path is eliminated or reduced.

It is preferred that a conductive powder that is a collection of the conductive particles 10, 10a each using the Ni core 11 (hereinafter referred to as “Ni powder”) have a median diameter d50 in a cumulative volume distribution curve of 3 μm or more and 100 μm or less, and satisfy (d90−d10)/d50≦0.8. The median diameter d50 may be used as a measure of the average particle diameter of the Ni powder. In addition, when (d90−d10)/d50 is more than 0.8, the variation in particle diameter is large, suggesting the presence of a conductive particle having a small particle diameter, which is not brought into contact with a wire or an electrode in the conductive path, and hence there is a risk in that connection reliability may be lowered. d10 and d90 represent particle diameters at cumulative volume fractions of 10% and 90%, respectively. The term “particle size distribution” as used herein refers to a particle size distribution determined by a laser diffraction/scattering method unless otherwise described.

As the Ni core 11 of the conductive particle 10, 10a, for example, the conductive particle disclosed in Patent Document No. 2 or 3 may be suitably used. A Ni powder that is a conductive powder produced by the production method disclosed in Patent Document No. 3 is monodispersed and has a narrow particle size distribution, and hence has an advantage in that a Ni powder satisfying the relationship of (d90−d10)/d50≦0.8 can be easily produced.

The Ni core 11 contains nickel (Ni) as a main component and contains phosphorus (P). P may be added as a starting component in a reaction treatment liquid for the purpose of promoting the growth of a core through reductive precipitation of Ni in a metal ball manufacturing process for the Ni core 11. The amount of P to be incorporated into the Ni core 11 is preferably as small as possible for the reason that the volume resistivity of the Ni core 11 itself is to be lowered. Specifically, in order that the Ni core 11 may exhibit the action and effect of the present invention, a Ni core containing 5 mass % to 15 mass %, preferably 10 mass % or less of P with respect to the entirety of the Ni core is used because an increase in volume resistivity of the Ni core 11 is remarkable when the content of P is more than 15 mass %.

In addition, the Ni core 11 may contain, besides P described above, 0.01 mass % to 18 mass % of copper (Cu) with respect to the entirety of the Ni core 11. Cu may be added as a starting component in the reaction treatment liquid for the purpose of suppressing the growth and aggregation of the cores. The amount of Cu to be incorporated into the Ni core 11 is preferably as small as possible for the reason that the volume resistivity of the Ni core 11 itself is to be lowered. When the content of Cu is more than 18 mass %, there is even a risk in that adhesiveness between the Ni core 11 and the first plating layer 12 may be lowered.

In addition, the Ni core 11 may contain, besides P and Cu described above, 0.05 mass % to 10 mass % of tin (Sn) with respect to the entirety of the Ni core 11. Like Cu, Sn may be added as a starting component in the reaction treatment liquid for the purpose of suppressing the growth and aggregation of the cores. The amount of Sn to be incorporated into the Ni core 11 is preferably as small as possible for the reason that the volume resistivity of the Ni core 11 itself is to be lowered. When the content of Sn is more than 10 mass %, there is even a risk in that the adhesiveness between the Ni core 11 and the first plating layer 12 may be lowered.

Each of Cu and Sn described above acts as a catalyst poison in a nucleation reaction in the production of powder to be used for the Ni core 11, and hence enables easy production of a powder that is monodispersed and has a narrow particle size distribution. In addition, Cu and Sn are coprecipitated in the growth process of the NiP conductive particle.

The first plating layer 12 to be formed on the surface of the Ni core 11 is a pure Ni plating layer or a Ni plating layer containing 4.0 mass % or less of P (hereinafter referred to as “low P—Ni plating layer”). The pure Ni plating layer may be formed by an electroless plating method or an electroplating method. The low P—Ni plating layer is generally formed by an electroless reduction plating method.

The thickness of the first plating layer 12 is preferably 0.1 μm or more and 10 μm or less. When the thickness of the first plating layer 12 is less than 0.1 μm, there is a risk in that the volume resistivity of the particle (conductive particle 10) having the first plating layer 12 on the surface of the Ni core 11 may not become sufficiently small. In addition, the case where the thickness of the first plating layer 12 is increased to more than 10 μm is uneconomical in terms of cost and not practical because the volume resistivity of the particle (conductive particle 10) having the first plating layer 12 on the surface of the Ni core 11 does not undergo a particular change commensurate with the thickness increase.

It is preferred that the first plating layer 12 be formed on the surface of the Ni core 11, and the Au plating layer 13 be further formed on the surface of the first plating layer 12, to thereby form the particle (conductive particle 10a). The volume resistivity of the conductive particle 10a having the Au plating layer 13 at its outermost surface can be made smaller than that of the particle (conductive particle 10) having the first plating layer 12 on the surface of the Ni core 11. The Au plating layer 13 is generally formed by an electroless plating method, and an electroless displacement plating method is preferred to an electroless reduction plating method. The Au plating layer 13 formed by the electroless displacement plating method (electroless displacement Au plating layer) has better adhesiveness with the first plating layer 12 (pure Ni plating layer or low P—Ni plating layer) than that of an electroless reduction Au plating layer.

The thickness of the Au plating layer 13 is preferably 5 nm or more and 200 nm or less. When the thickness of the Au plating layer 13 is less than 5 nm, there is a risk in that the volume resistivity of the conductive particle 10a may not be made sufficiently smaller than that of the particle (conductive particle 10) having the first plating layer 12 on the surface of the Ni core 11. In addition, the case where the thickness of the Au plating layer 13 is increased to more than 200 nm is uneconomical in terms of cost and not practical because the volume resistivity of the conductive particle 10a does not undergo a particular change commensurate with the thickness increase. From the viewpoints of the volume resistivity-reducing effect and the cost described above, the thickness of the Au plating layer 13 is more preferably 10 nm or more and 100 nm or less. When a Au plating layer having a thickness as large as, for example, 50 nm or more and 200 nm or less is to be formed, the following plating treatment may be performed: a Au plating layer having a thickness of, for example, 50 nm is formed by an electroless displacement/reduction plating method involving performing electroless displacement Au plating and electroless reduction Au plating in one plating treatment, or by the electroless displacement plating method, and then the thickness of the Au plating layer is increased to, for example, 150 nm by the electroless reduction plating method.

The conductive particle 10 according to the embodiment of the present invention includes the Ni core 11, and the first plating layer 12 (pure Ni plating layer or low P—Ni plating layer) covering the surface of the Ni core 11, and hence its volume resistivity can be made particularly smaller than that of a related-art NiP particle (conductive particle). Accordingly, through the application of the conductive particle 10 according to the embodiment of the present invention, a Ni powder (conductive powder) having a smaller volume resistivity and better conductivity can be obtained than through the use of the related-art NiP particle. In addition, a conductive polymer composition and an anisotropic conductive sheet each using the Ni powder and having good conductivity can be obtained.

In addition, in the conductive particle 10a according to the other embodiment of the present invention, the Au plating layer 13 having better conductivity than that of the first plating layer 12 (pure Ni plating layer or low P—Ni plating layer) covers the surface of the conductive particle 10, and hence its volume resistivity can be made even smaller than that of the conductive particle 10. Accordingly, through the application of the conductive particle 10a according to the other embodiment of the present invention, a Ni powder (conductive powder) having a smaller volume resistivity and better conductivity can be obtained than through the use of a conductive particle having a Au plating layer on the surface of the related-art NiP particle. In addition, a conductive polymer composition and an anisotropic conductive sheet each using the Ni powder and having good conductivity can be obtained.

The conductive particles 10, 10a according to the embodiments of the present invention may be produced by, for example, the following method.

First, a Ni powder that is a collection of the spherical Ni cores 11 each containing P is prepared. In this case, a Ni powder produced by the method disclosed in Patent Document No. 3 is preferred.

Specifically, nickel sulfate hexahydrate, copper sulfate pentahydrate, and sodium stannate trihydrate were prepared so that the molar ratio of Ni, Cu, and Sn was 0.29:0.01:0.05, and were dissolved in pure water to produce 15 (dm³) of a metal salt aqueous solution. By blending copper sulfate pentahydrate, and further, sodium stannate trihydrate, a NiP particle containing Cu, and further, Sn as described above is produced, and exhibits, for example, the following action and effect: NiP particle diameters (particle diameters) are easily uniformized, and the diameters of particles can be increased easily and stably. Next, sodium acetate was dissolved in pure water to a concentration of 1.0 (kmol/m³), and sodium hydroxide was further added to produce 15 (dm³) of a pH-adjusting aqueous solution. Then, the metal salt aqueous solution described above and the pH-adjusting aqueous solution were stirred and mixed to prepare 30 (dm³) of a mixed aqueous solution, and its pH was measured to show a value of 8.1. Then, while the mixed aqueous solution was bubbled with N₂ gas, the mixed aqueous solution was heated to and kept at 343 (K) with an external heater, and stirring was continued. Next, 15 (dm³) of a reducing agent aqueous solution having sodium phosphinate (sodium hypophosphite) dissolved at a concentration of 1.8 (kmol/m³) in pure water was produced, and the reducing agent aqueous solution was also heated with an external heater to 343 (K). Then, 30 (dm³) of the mixed aqueous solution described above and 15 (dm³) of the reducing agent aqueous solution, each of which had been prepared so as to have a temperature of 343±1 (K), were mixed.

Through the use of the thus prepared electroless reduction plating liquid, a Ni powder was obtained by an electroless reduction plating method. The Ni core 11 forming the produced Ni powder had a component composition containing 7.4 mass % of P, 3.9 mass % of Cu, and 0.3 mass % of Sn, and the balance of Ni. Even when copper sulfate pentahydrate serving as a Cu source and sodium stannate trihydrate serving as a Sn source are not blended into the electroless reduction plating liquid, a NiP particle can be produced in the same manner as in the method described above. In this case, the NiP particle does not contain Cu or Sn.

In the following, in each of Examples 1 to 7 and Comparative Examples 1 and 2, a Ni powder having a median diameter d50 of 20 μm and a (d90−d10)/d50 of 0.7 was used as the Ni powder to be used for the Ni core. In addition, in Comparative Example 3, a Ni powder having a median diameter d50 of 6 μm and a (d90−d10)/d50 of 0.7 was used as the Ni powder to be used for the Ni core.

### Example 1

The Ni core 11 produced by the method described above was used, and a low P—Ni plating layer (first plating layer 12) was formed on the surface of the Ni core 11. Specifically, an electroless reduction Ni plating liquid having a predetermined component composition (hereinafter referred to as “Ni plating liquid”) was prepared, and heated with an external heater to adjust the temperature of the Ni plating liquid as predetermined. Next, while the Ni plating liquid was stirred, the Ni concentration in the liquid was adjusted as predetermined. After that, the Ni core 11, which had been subjected to an acid treatment for removing an oxide film on its surface and then washed with water, was loaded into the Ni plating liquid. Then, a conductive particle 10 having a low P—Ni plating layer (first plating layer 12) having a thickness of about 1.3 pun on the surface of the Ni core 11 was obtained by an electroless reduction plating method. The low P—Ni plating layer was qualitatively analyzed by energy dispersive X-ray spectroscopy (EDX), and as a result, was found to contain 1.4 mass % of P and the balance of Ni.

### Example 2

On the surface of the conductive particle 10 obtained in Example 1, that is, the surface of the low P—Ni plating layer (first plating layer 12), the Au plating layer 13 (second plating layer) was further formed. Specifically, an electroless displacement Au plating liquid (hereinafter referred to as “displacement-type Au plating liquid”) was prepared, and heated with an external heater to adjust the temperature of the displacement-type Au plating liquid as predetermined. Next, while the displacement-type Au plating liquid was stirred, the Au potassium cyanide concentration in the liquid was adjusted to adjust its Au concentration as predetermined. After that, the conductive particle 10, which had been subjected to an acid treatment and washed with water, was loaded into the displacement-type Au plating liquid. Then, a conductive particle 10a having an electroless Au plating layer (second plating layer) having a thickness of about 20 nm on the surface of the low P—Ni plating layer was obtained by an electroless displacement plating method.

### Example 3

In the same manner as Example 1 described above, a conductive particle 10 having a low P—Ni plating layer (first plating layer 12) having a thickness of about 2.6 μm on the surface of the Ni core 11 was obtained by an electroless reduction plating method in which the Ni concentration in the Ni plating liquid was changed. The low P—Ni plating layer was qualitatively analyzed by EDX, and as a result, was found to contain 1.3 mass % of P and the balance of Ni.

### Example 4

In addition, in the same manner as in Example 2 described above, a conductive particle 10a having an electroless Au plating layer (second plating layer) having a thickness of about 20 nm on the surface of the low P—Ni plating layer (first plating layer 12) of the conductive particle 10 obtained in Example 3 was obtained by an electroless displacement plating method.

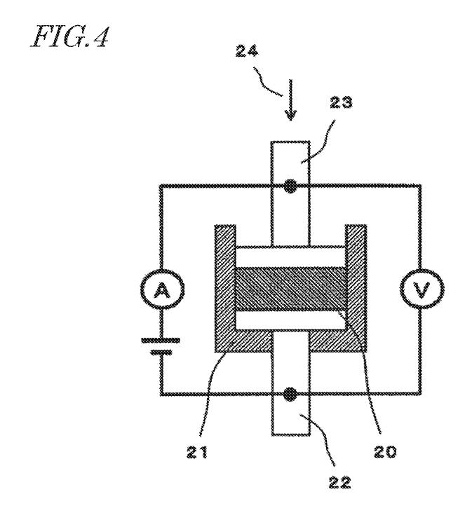

In FIG. 3, for the conductive particle 10a including the Ni core 11, the low P—Ni plating layer 12, and the Au plating layer 13, which was obtained in Example 4, an image (cross-sectional SEM image) of a cross-section thereof observed with a scanning electron microscope (SEM) is shown. A state in which the periphery of the NiP core 11 is covered with the low P—Ni plating layer 12 is confirmed. In the cross-sectional SEM image shown in FIG. 3, the presence of the Au plating layer 13 having a thickness of about 20 nm is difficult to confirm.

### Example 5

The conductive particle 10 having the low P—Ni plating layer (first plating layer 12) having a thickness of about 2.6 μm on the surface of the Ni core 11, which was obtained in Example 3 described above, was used, and a conductive particle 10a having a Au plating layer 13 (second plating layer) having a thickness of about 100 nm on the surface of the low P—Ni plating layer was obtained. Specifically, a general-purpose electroless Au plating liquid capable of substantially simultaneously performing electroless displacement Au plating treatment and electroless reduction Au plating treatment in one plating treatment was prepared, and heated with an external heater to adjust the temperature of the electroless Au plating liquid as predetermined. Next, while the electroless Au plating liquid was stirred, the Au potassium cyanide concentration in the liquid was adjusted to adjust its Au concentration as predetermined. After that, the conductive particle 10, which had been subjected to an acid treatment and washed with water, was loaded into the electroless Au plating liquid. Then, the conductive particle 10a having the electroless Au plating layer (second plating layer) having a thickness of about 100 nm on the surface of the low P—Ni plating layer (first plating layer 12) was obtained by an electroless displacement Au plating method and an electroless reduction Au plating method.

### Example 6

The Ni core 11 produced by the method described above was used, and a high-purity pure Ni plating layer (first plating layer 12) substantially free of a metalloid, for example, P, was formed on the surface of the Ni core 11. Specifically, an electroless reduction Ni plating liquid having such a predetermined component composition that an element except Ni, such as P, was to be hardly incorporated into the plating layer (hereinafter referred to as “pure Ni plating liquid”) was prepared, and heated with an external heater to adjust the temperature of the pure Ni plating liquid as predetermined. Next, while the pure Ni plating liquid was stirred, the Ni concentration in the liquid was adjusted as predetermined. After that, the Ni core 11, which had been subjected to an acid treatment for removing an oxide film on its surface and then washed with water, was loaded into the pure Ni plating liquid. Then, a conductive particle 10 having a pure Ni plating layer (first plating layer 12) having a thickness of about 0.9 μm and containing less than 0.1 mass % of P on the surface of the Ni core 11 was obtained by an electroless reduction plating method.

### Example 7

In addition, in the same manner as in Example 1 described above, a conductive particle 10a having an electroless Au plating layer (second plating layer) having a thickness of about 20 nm on the surface of the pure Ni plating layer (first plating layer 12) of the conductive particle 10 obtained in Example 6 was obtained by an electroless displacement plating method.

### Comparative Example 1

The Ni core 11 produced by the method described above is used as Comparative Example 1. That is, the Ni core 11 does not have the first plating layer 12 (pure Ni plating layer or low P—Ni plating layer) or the second plating layer (Au plating layer 13), and hence may be considered to be a conductive particle substantially equivalent to a related-art NiP particle.

### Comparative Example 2

The Ni core 11 produced by the method described above was used, and a Au plating layer was formed on the surface of the Ni core 11. Specifically, in the same manner as in Example 1 described above, a conductive particle having an electroless Au plating layer having a thickness of about 20 nm on the surface of the Ni core 11 (hereinafter referred to as “Ni core-Au plating particle”) was obtained by an electroless displacement plating method.

### Comparative Example 3

By a method similar to that for the Ni core 11 described above, a Ni core 11 having a component composition containing 7.9 mass % of P, 3.3 mass % of Cu, and 0.4 mass % of Sn, and the balance of Ni and having a diameter of the particle (particle diameter) of 6 μm (hereinafter referred to as “Ni core 11a” to be distinguished from the Ni core 11 in each of Examples 1 to 4 and Comparative Examples 1 and 2) was obtained. Next, a Pd plating layer formed of palladium (Pd) was formed on the surface of the obtained Ni core 11a. Specifically, an electroless reduction Pd plating liquid having a predetermined component composition (hereinafter referred to as “Pd plating liquid”) was prepared, and heated with an external heater to adjust the temperature of the Pd plating liquid as predetermined. Next, while the Pd plating liquid was stirred, the Pd concentration in the liquid was adjusted as predetermined. After that, the Ni core 11a, which had been subjected to an acid treatment for removing an oxide film on its surface and then washed with water, was loaded into the Pd plating liquid. Then, a conductive particle having an electroless Pd plating layer having a thickness of about 30 nm on the surface of the Ni core 11a (hereinafter referred to as “Ni core-Pd plating particle”) was obtained by an electroless reduction plating method.

For each of the conductive particles of Examples 1 to 7 and Comparative Examples 1 to 3 obtained as described above, the diameter of the Ni core (particle diameter), the kinds and thicknesses of the first plating layer and the second plating layer, and the volume resistivity are shown in Table 1.

TABLE 1

| | Particle | Thickness | | | | | |
|---|---|---|---|---|---|---|---|
| | diameter | of plating | | Thickness | | | |
| | of Ni | layer (μm) | | of plating | | Volume | |
| | core | Low | Pure | layer (μm) | | resistivity | |
| | (μm) | P—Ni | Ni | Au | Pd | (×10⁻⁵ Ωm) | Remark |
| Example 1 | 20 | 1.3 | — | — | — | 1.7 | Ni core, first plating layer |
| Example 2 | 20 | 1.3 | — | 20 | — | 0.4 | Ni core, first plating layer, |
| | | | | | | | second plating layer |
| Example 3 | 20 | 2.6 | — | — | — | 1.3 | Ni core, first plating layer |
| Example 4 | 20 | 2.6 | — | 20 | — | 0.3 | Ni core, first plating layer, |
| | | | | | | | second plating layer |
| Example 5 | 20 | 2.6 | — | 100 | — | 0.2 | Ni core, first plating layer, |
| | | | | | | | second plating layer |
| Example 6 | 20 | — | 0.9 | — | — | 0.8 | Ni core, first plating layer |
| Example 7 | 20 | — | 0.9 | 20 | — | 0.3 | Ni core, first plating layer, |
| | | | | | | | second plating layer |
| Comparative | 20 | — | — | — | — | 35.0 | Ni core (NiP particle) |
| Example 1 | | | | | | | |
| Comparative | 20 | — | — | 20 | — | 0.7 | Ni core-Au plating particle |
| Example 2 | | | | | | | |
| Comparative | 6 | — | — | — | 30 | 0.7 | Ni core-Pd plating particle |
| Example 3 | | | | | | | |

The volume resistivity Rc of a conductive particle was measured using a conductive powder that was a collection of the conductive particles as a sample powder and using a measurement apparatus of the structure illustrated in FIG. 4. Specifically, 1.15 g of a sample powder 20 was placed in a cylinder 21 having an inner diameter D in which a copper jig 22 was arranged in a bottom portion. Under a state in which a load of about 22 MPa was applied with a copper piston 23 from the opening side of the cylinder 21 in the direction of an arrow 24, a distance L between the copper jig 22 and the copper piston 23 was kept constant. The copper jig 22 and the copper piston 23 were produced so that their resistance values were substantially equivalent to each other. Next, a current was applied between the copper jig 22 and the copper piston 23, and a resistance value Rm was measured with a commercially available resistance meter (Resistance Meter 3541 manufactured by Hioki E.E. Corporation). With the thus measured resistance value Rm (Q) of the entire system, a resistance value Rj (Ω) of the copper jig 22 and the copper piston 23, and the inner diameter D (m) and the distance L (m), the equation Rc=(Rm−Rj)×Π×(D/2)²/L was used to determine the volume resistivity Rc (Ωm) of the conductive particle.

The thickness of each of the pure Ni plating layer and the low P—Ni plating layer was determined by arithmetically averaging thicknesses measured at a plurality of sites on the plating layer observed in a cross-sectional SEM image of the conductive particle. In addition, the thickness of each of the Au plating layer when the first plating layer was present, and the Pd plating layer was determined using the chemical components and mass of the conductive particle, the density and particle diameter (median diameter) of the Ni core, the total surface area, and the theoretical density of the constituent element, such as Au or Pd, of the plating layer, and using the following equation: thickness of plating layer (μm)=(mass % of plating layer/100)×(1/density of constituent element of plating layer (g/cm³))×(1/total surface area of Ni core having first plating layer (cm²))×10,000. When the first plating layer was not present, the total surface area (cm²) of the Ni core was used in place of the above-mentioned total surface area. The chemical components of the conductive particle may be analyzed using an ICP emission spectrometer after dissolving a certain amount of the conductive particle in, for example, aqua regia, and diluting the solution with pure water. For the dissolution of Ni, a nitric acid-based solution may also be used. In addition, the density of Au is 19.32 g/cm³, the density of Pd is 11.99 g/cm³, and the density of the Ni core is 7.8 g/cm³. In addition, the total surface area of the Ni core having the first plating layer was determined as the product of the surface area of a Ni core having one first plating layer (surface area of a sphere having the median diameter d50) and the total number of Ni cores each having the first plating layer contained in the sample powder.

(Volume Resistivity of Conductive Particle 10)

The volume resistivity shown in Table 1 in the case of the conductive particle 10 having the first plating layer 12 (low P—Ni plating layer or pure Ni plating layer) on the surface of the Ni core 11 according to the present invention (Example 1, 3, or 6) was from about 0.03 times (Example 6) to about 0.05 times (Example 1) as large as that of the related-art NiP particle (Comparative Example 1). Therefore, the conductive particle 10 according to the present invention was confirmed to have a particularly smaller volume resistivity than that of a related-art conductive particle (NiP particle).

(Volume Resistivity of Conductive Particle 10a)

The volume resistivity shown in Table 1 in the case of the conductive particle 10a having the Au plating layer 13 on the surface of the first plating layer 12 according to the present invention (Example 2, 4, or 5) was from about 0.29 times (Example 5) to about 0.57 times (Example 2) as large as that of the related-art conductive particle having the Au plating layer or the Pd plating layer (Comparative Example 2 or 3). Therefore, the conductive particle 10a according to the present invention was confirmed to have a smaller volume resistivity than that of a related-art conductive particle (Ni core-Au plating particle or Ni-core Pd plating particle).

(Thickness of First Plating Layer)

In a comparison between Example 1 and Example 3 each using the low P—Ni plating layer, Example 3, in which the thickness of the plating layer was twice as large as that in Example 1, had a volume resistivity about 0.76 times as large as that of Example 1. In addition, in a comparison between the low P—Ni plating layer (Example 4) and the pure Ni plating layer (Example 7) with the Au plating layers being further formed with the same thickness, their volume resistivities were equal to each other. Therefore, in the case of selecting the low P—Ni plating layer as the first plating layer 12 of the conductive particle 10 illustrated in FIG. 1, it was found that: it was preferred that the thickness of the low P—Ni plating layer be increased; and the volume resistivity of the conductive particle 10 was able to be further decreased. In this regard, it is considered that the same tendency occurs in the case of selecting the pure Ni plating layer as the first plating layer 12 of the conductive particle 10 illustrated in FIG. 1, and it is considered that as the thickness of the pure Ni plating layer increases, the volume resistivity decreases.

(Kind of First Plating Layer)

In a comparison between the low P—Ni plating layer (Example 3) and the pure Ni plating layer (Example 6), the pure Ni plating layer (Example 6) having a thickness of the plating layer about 0.35 times as large as that of the low P—Ni plating layer (Example 3) had a volume resistivity about 0.62 times as large as that of Example 3. Therefore, in the case of selecting the kind of the first plating layer 12 of the conductive particle 10 illustrated in FIG. 1, it was found that the pure Ni plating layer was preferred. The low P—Ni plating layer has a high formation rate of the plating layer as compared to the pure Ni plating layer, and hence has advantages in practical use, such as a short plating treatment time and an inexpensive plating liquid.

(Thickness of Au Plating Layer)

In a comparison between Example 4 and Example 5, in which the Au plating layers 13 having different thicknesses were formed on the surfaces of the conductive particles 10 having the same structures of the Ni core 11 and the low P—Ni plating layer, Example 5, in which the thickness of the Au plating layer was 5 times as large as that in Example 4 (larger by 80 nm), had a volume resistivity about 0.67 times as large as that of Example 4 (smaller by 0.1×10⁻⁵ am). Therefore, although it is also preferred that the Au plating layer be made thicker, from the viewpoint of cost reduction, it is considered that it is preferred that the pure Ni plating layer be selected as the first plating layer and the thickness of the pure Ni plating layer be increased.

As described above, it was able to be confirmed that according to the embodiments of the present invention, the volume resistivity of the conductive particle formed of the NiP particle having no Au plating layer at its outermost surface was able to be made particularly smaller than that of the related art. In addition, in the case of conductive particles each formed of a NiP particle having a Au plating layer of the same thickness at its outermost surface, it was able to be confirmed that the volume resistivity was able to be made smaller than that of the related art. Therefore, it is considered that according to the present invention, depending on required conductive performance, cost reduction can be achieved by making the thickness of the Au plating layer smaller than that of the related art. Specifically, for example, when a conductive particle having a volume resistivity of about 0.7×10⁻⁵ Ωm (corresponding to Comparative Example 2) is required, in consideration of the fact that the thickness of the Au plating layer of the conductive particle having a volume resistivity of 0.4×10⁻⁵ Ωm (Example 2) is 20 nm, it is considered that even when the thickness of the Au plating layer of the conductive particle is decreased to about 10 nm, a volume resistivity of about 0.7×10⁻⁵ Ωm can be obtained.

The conductive powder according to the embodiment of the present invention is a collection of the above-mentioned conductive particles according to the present invention each having a smaller volume resistivity and better conductivity than those of the related art, the conductive particles being sorted out so as to have a median diameter d50 in a cumulative volume distribution curve of 3 μm or more and 100 μm or less, and to satisfy (d90−d10)/d50≦0.8. Such conductive powder may be obtained by: preparing a collection of the conductive particles according to the present invention; sorting out such conductive particles that the d50 falls within the range of from 3 μm or more to 100 μm or less by, for example, a sieving method; and further similarly sorting out the conductive particles satisfying (d90−d10)/d50≦0.8. In actuality, for example, a conductive powder in which the d50 was 20 μm and (d90−d10)/d50 was 0.7 was able to be obtained. Therefore, the conductive powder according to the present invention is a conductive powder having a smaller volume resistivity than that of the related art, a sharp particle size distribution with a small variation, and good conductivity.

The conductive polymer composition according to the embodiment of the present invention includes: the above-mentioned conductive powder that is a collection of the conductive particles according to the present invention having a smaller volume resistivity and better conductivity than those of the related art; and a polymer. Therefore, the conductive polymer composition according to the present invention is a conductive polymer composition having a smaller volume resistivity and better conductivity than those of the related art. Unless otherwise described, the polymer has an electrically insulating property. Any of various known polymer materials may be used as the polymer depending on applications. The polymer material is, for example, a rubber, a thermoplastic resin, a thermosetting resin, or a photocurable resin. The conductive polymer composition according to the embodiment of the present invention can be widely used for an anisotropic conductive sheet (ACF), an anisotropic conductive paste (ACP), and the like. The content of the conductive particles is appropriately set depending on applications, but is generally 3% or more and 50% or less, preferably 5% or more and 30% or less in terms of volume fraction.

The conductive particle 10 and the conductive particle 10a forming the conductive powder described above are each the conductive particle according to the present invention having a smaller volume resistivity and better conductivity than those of the related art, the conductive particle including the Ni core 11 mainly formed of Ni, and hence each exhibit ferromagnetism. Therefore, through the application of the polymer composition of the embodiment according to the present invention, an anisotropic conductive sheet in which the conductive particles 10 or the conductive particles 10a are continuously arranged at substantially equal intervals in the thickness direction of the sheet by virtue of a magnetic field can be formed. Therefore, the anisotropic conductive sheet according to the present invention is an anisotropic conductive sheet having better conductivity by virtue of a smaller volume resistivity than that of the related art in the thickness direction, and having an enhanced anisotropic property because the conductivity is relatively suppressed as compared to that of the related art in a sheet surface direction orthogonal to the thickness direction. In this case, when a rubber (or an elastomer) is used as the polymer, a pressure-sensitive anisotropic conductive sheet can be obtained. The pressure-sensitive anisotropic conductive sheet has a property of exhibiting conductivity only when pressurized (compressed) in the thickness direction of the sheet and exhibiting an insulating property again when the pressurization is stopped. The pressure-sensitive anisotropic conductive sheet is suitably used in an application in which electrical connection is temporarily formed in, for example, an inspection of a circuit board, a semiconductor device, or the like. Any of various known rubbers (including elastomers) may be used as the rubber. From the viewpoints of processability, heat resistance, and the like, a curable silicone rubber is preferred.

The ACF and the ACP are used also for the formation of electrical connection in electrical devices, such as liquid crystal display apparatus, tablet PCs, and cellular phones. In those applications, a thermosetting resin or a photocurable resin is used as the polymer. For example, any of various epoxy resins is used as the thermosetting resin, and an acrylic resin is used as the photocurable resin.

### INDUSTRIAL APPLICABILITY

The present invention is applicable to a conductive particle, a conductive powder, a conductive polymer composition, and an anisotropic conductive sheet.

### REFERENCE SIGNS LIST

10 conductive particle
10a conductive particle
11 Ni core (NiP particle)
12 first plating layer
13 Au plating layer
20 sample powder
21 cylinder
22 copper jig
23 copper piston
24 arrow

1. A conductive particle, comprising:
a spherical Ni core containing 5 mass % or more and 15 mass % or less of P; and
a first plating layer covering a surface of the Ni core,
wherein the first plating layer comprises a pure Ni plating layer or a Ni plating layer containing 4.0 mass % or less of P.

2. The conductive particle according to claim 1, wherein the first plating layer has a thickness of 0.1 μm or more and 10 μm or less.

3. The conductive particle according to claim 1, wherein the Ni core has a diameter of 1 μm or more and 100 μm or less.

4. The conductive particle according to claim 1, further comprising a second plating layer covering a surface of the first plating layer, wherein the second plating layer comprises a Au plating layer having a thickness of 5 nm or more and 200 nm or less.

5. A conductive powder, comprising the conductive particles of claim 1, the conductive powder having a median diameter d50 in a cumulative volume distribution curve of 3 μm or more and 100 μm or less, and satisfying [(d90−d10)/d50]≦0.8.

6. A conductive polymer composition, comprising:
the conductive powder of claim 5; and
a polymer,
wherein the polymer comprises a rubber, a thermoplastic resin, a thermosetting resin, or a photocurable resin.

7. An anisotropic conductive sheet, comprising the conductive polymer composition of claim 6, wherein the conductive particles are arranged in a thickness direction of the anisotropic conductive sheet.
